(19) United States
(12) Patent Application Publication
(10) Pub. No.: US 2005/0105799 A1
(43) Pub. Date: May 19, 2005

(54) Dynamic typography system

(75) Inventors: Carol Strohecker, Dublin (IE); Andrea Taylor, Dublin (IE); Zoltan Foley-Fisher, Co. Westmeath (IE)

Correspondence Address: CHARLES G. CALL, 68 HORSE POND ROAD, WEST YARMOUTH, MA, 02673-2516, US

(73) Assignee: Media Lab Europe, Dublin (IE)

(21) Appl. No.: 10/991,130

(22) Filed: Nov. 17, 2004

Related U.S. Application Data
(60) Provisional application No. 60/520,823, filed on Nov. 17, 2003.

(51) Int. Cl. G06K 9/18

(52) U.S. Cl. 382/186

(57) ABSTRACT

A system for capturing and reproducing handwriting. The writer employs a stylus or pen in combination with a digital writing tablet that captures the gestural movements of the stylus during writing, as well as the timing and rhythm of the strokes. A recognition engine analyzes the gestural movement data and produces a sequence of values identifying characters in a character set, as well as additional pictogram data which records the shape of non-character data written on the tablet. The recognition engine further generates ancillary data which further describes individual characters or groups of characters, specifying their size, slope, absolute position, applied stylus pressure, timing and rhythm, color, spacing, and other data that enables a rendering engine to select a font to represent the original handwriting and to further modify the selected font representation of the characters or groups of characters in a manner specified by the ancillary data.

### CROSS REFERENCE TO RELATED APPLICATIONS

This application is a Non-Provisional of, and claims the benefit of the filing date of, U.S. Provisional Patent Application Ser. No. 60/520,823 filed Nov. 17, 2003, the disclosure of which is incorporated herein by reference.

### FIELD OF THE INVENTION

This invention relates to handwriting recognition, storage, translation and transmission systems.

### SUMMARY OF THE INVENTION

In a preferred embodiment of the invention, gestural attributes of handwriting are translated into data identifying letterform font characters and attributes, which specifies modifications to the font or fonts, and/or to characteristics of a range of fonts, creating a dynamic typography. The attributes may be further mapped to pictographs which are meaningfully interspersed with the letterforms. Still further, these and other gestural attributes may also be mapped to musical structures, generating sounds to accompany the script and/or picture writing.

The sensed and translated handwriting attributes are selected from a group including: character height and width, letter spacing, slant, baseline, line spacing, stroke acuity, the form and degree of connection between adjacent characters or pictographs, and the pressure, stroke speed, rhythm and flourishes applied to the writing instrument. The system can be expanded to include additional attributes and/or to vary the combinations of such attributes.

The typographic translations which are performed by the combination of the recognition engine and the rendering engine are selected from a group including: size, character width, letter spacing, slope, baseline, line spacing, font, phrasing, position, opacity, character definition, rhythm, ornament and color. The system can be expanded to include additional mappings and/or to vary the combinations of such mappings. The pictographic translations are performed with respect commonly recognizable, dynamically scalable images associated with a specified content domain.

The preferred embodiment of the invention takes the form of methods and apparatus for capturing, storing and rendering handwriting which includes (1) input means for capturing input data representing handwriting gestures which produce characters and other graphical images; (2) a recognition engine for translating the captured gestural representation data into character data specifying an ordered sequence of characters in a character set and additional ancillary attribute data specifying the visual characteristics of individual characters or groups of characters; (3) a font storage library for storing visual symbols representing each of the recognized characters in a selected one of a plurality of different font styles; and (4) a rendering engine for converting the character data and the ancillary attribute data into a visual representation of the original handwriting gestures by selecting a font style in said font store for best representing the individual characters or groups of characters specified by the character data in a specific font and from selected in accordance with the ancillary attribute data.

The input means may take the form of the combination of a writing stylus, a writing surface, and means for capturing input data representing the motion of the writing stylus with respect to the writing surface, and also optionally capturing input data representing the magnitude of pressure applied to the writing surface by the writing stylus. Additionally, an mechanism may be employed to capture the color of the handwriting and of the background as well as capturing input timing data representing the timing or rhythm of said handwriting gestures including data representing the amplitude, duration, velocity or rhythm, pitch and timbre of the strokes. The system can be expanded to include additional mappings and/or to vary the combinations of such mappings.

In a related implementation, inputs include modalities other than text or additional to text which are translated to text or other modalities or combinations of such modalities. For example a built-in microphone captures sounds for such translating and a built-in miniature camera captures images for such translating. Each mode may be used singly or in combination with others as input or translated output. In a further implementation, the intermodal capabilities are situated within a communications platform. Haptic forces such as pressures and vibrations effect and signal sending and receiving of user-generated examples of the intermodal form or forms. Dynamic databases accept, organize and deliver such user-generated examples to be used as inputs for modal translation, alternatively to users' gestural input.

An electronic pen or stylus and tablet effect the sensing and gestural input information and the textual, pictorial and sound output or combinations of these.

### BRIEF DESCRIPTION OF THE DRAWINGS

In the detailed description which follows, frequent reference will be made to the attached drawngs, in which:

FIG. 1 is a block diagram illustrating an embodiment of the invention.

### DETAILED DESCRIPTION

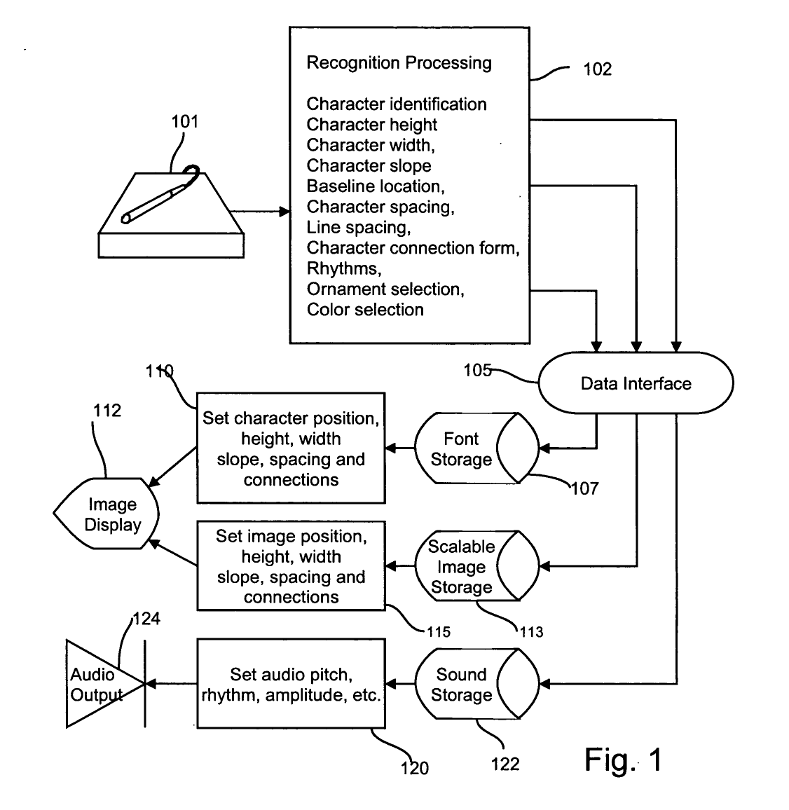

The principal components and processing steps used in an illustrative embodiment of the invention are shown in FIG. 1.

An electronic pen or stylus and a writing tablet as seen at 101 are employed to capture the position the point of contact at which the moving pen or stylus touches a digitizing tablet, thereby capturing gestural input information which is oassed to a character and image recognition processing engine at 102. In addition, the pen or stylus and/or the writing tablet may capture haptic forces such as stylus pressures and vibrations thereby producing additional information characterizing the writer's gestures which may me used to vary the ultimate visual and/or audible and/or haptic output that characterizes the original gestural movements.

Gestural input information may also be captured using optical character recognition techniques by interpreting handwritten symbols recorded on a writing medium and then scanned or otherwise processed to form image data, such as a bit-mapped TIFF image. OCR techniques are then used to convert the image data into coded signals representing characters, individual graphic images, and additional information describing the attributes of the gestures used to create the characters as originally hand written. Note that, if the image data which is optically recognized includes text printed in a predetermined font, the recognition engine may recognize not only the characters but also may capture and store the font which, if available in the font storage unit 107 to be described later, may be selected and used. For handwritten characters, however, ancillary attribute data is captured and stored, and that data is used at the time the character and attribute data is rendered to select particular font styles and to perhaps further modify the character or glyph image available in font storage to more accurately replicate the original writing.

The character and image recognition engine 102 executes stored character recognition programs which may operate by comparing positional data from the input table 101 defining handwritten words or characters to stored recognition data (referred to as a dictionary) in an effort to identify specific characters and sequences of characters which may then be identified by digital codes, such as the 8 bit ASCII character set of the 16 bit Unicode character set.

Methods and apparatus for translating recognizing characters and images produced by handwriting are well known and are described in the following U.S. patents and U.S. Application Publications, the disclosures of which are incorporated herein by reference:
U.S. Pat. No. 6,137,908 issued on Oct. 24, 200 to Rhee; Sung Sik (Redmond, Wash.) (Microsoft Corporation) entitled Handwriting recognition system simultaneously considering shape and context information;
U.S. Pat. No. 6,330,359 issued on Dec. 11, 2001 Oct. 7, 1996 Kawabata; Kazuki (Osaka, JP) (Japan Nesamac Corporation) entitled Pen-grip type of input apparatus using finger pressure and gravity switches for character recognition;
U.S. Pat. No. 5,862,251 issued on Jan. 19, 1999 to Al-Karmi; Abdel N. (Unionville, Calif.); Singh; Shamsher S. (Rochester, Minn.); Soor; Baldev Singh (Markham, Calif.) (International Business Machines Corporation) entitled Optical character recognition of handwritten or cursive text;
U.S. Pat. No. 6,625,314 issued on Sep. 23, 2000 to Okamoto; Masayoshi (Kyoutanabe, J P) (Sanyo Electric Co., LTD) entitled Electronic pen device and character recognition method employing the same;
U.S. Pat. No. 6,493,464 issued on Dec. 10, 2000 to Hawkins; Jeffrey Charles (Redwood City, Calif.); Sipher; Joseph Kahn (Mountain View, Calif.); Marianetti, II; Ron (San Jose, Calif.) (Palm, Inc.) entitled Multiple pen stroke character set and handwriting recognition system with immediate response;
U.S. Pat. No. 6,389,166 issued on May 14, 2002 to Chang; Yi-Wen (Taipei Hsien, TW); Kuo; June-Jei (Taipei, TW) (Matsushita Electric Industrial Co., Ltd.) entitled On-line handwritten Chinese character recognition apparatus;
U.S. Pat. No. 6,289,124 issued on Sep. 11, 2001 on Apr. 26, 1999 to Okamoto; Masayoshi (Ogaki, JP) (Sanyo Electric Co., Ltd.) entitled Method and system of handwritten-character recognition;
U.S. Pat. No. 6,188,789 issued on Feb. 13, 2001 to Marianetti, II; Ronald (Morgan Hill, Calif.); Haitani; Robert Yuji (Cupertino, Calif.) (Palm, Inc.) entitled Method and apparatus of immediate response handwriting recognition system that handles multiple character sets;
U.S. Pat. No. 6,115,497 issued on Sep. 5, 2000 to Vaezi; Mehrzad R. (Irvine, Calif.); Sherrick; Christopher Allen (Irvine, Calif.) (Canon Kabushiki Kaisha) entitled Method and apparatus for character recognition;
U.S. Pat. No. 5,923,793 issued on Jul. 13, 1999 to Ikebata; Yoshikazu (Tokyo, JP) (NEC Corporation) entitled Handwritten character recognition apparatus with an improved feature of correction to stroke segmentation and method for correction to stroke segmentation for recognition of handwritten characters;
U.S. Pat. No. 5,784,504 issued on Jul. 21, 1998 to Anderson; William Joseph (Raleigh, N.C.); Anthony; Nicos John (Purdys, N.Y.); Chow; Doris Chin (Mt. Kisco, N.Y.); Harrison; Colin Geo (International Business Machines Corporation) entitled Disambiguating input strokes of a stylus-based input devices for gesture or character recognition;
U.S. Pat. No. 5,742,705 issued on Apr. 21, 1999 to Parthasarathy; Kannan (3316 St. Michael Dr., Palo Alto, Calif. 94306) entitled Method and apparatus for character recognition of handwritten input;
U.S. Application Publication No. 2001-0038711 published on Nov. 8, 2001 filed by Williams, David R.; (Pomona, Calif.); Richter, Kathie S.; (Pomona, Calif.) entitled Pen-based handwritten character recognition and storage system;
U.S. Application Publication No. 2002-0009226 published on Jan. 24, 2002 filed by Nakao, Ichiro; (Amagasaki, JP); Ito, Yoshikatsu; Handwritten character recognition apparatus;
U.S. Application Publication No. 2003-0190074 published on Oct. 9, 2003 filed by Loudon, Gareth H.; (Singapore, SG); Wu, Yi-Min; (Singapore, SG); Pittman, James A.; (Lake Oswego, Oreg.) entitled Methods and apparatuses for handwriting recognition;
U.S. Application Publication No. 2002-0196978 published on Dec. 26, 2002 filed by Hawkins, Jeffrey Charles; (Redwood City, Calif.); Sipher, Joseph Kahn; (Mountain View, Calif.); Marianetti, Ron II; (San Jose, Calif.) entitled Multiple pen stroke character set and handwriting recognition system with immediate response;
U.S. Application Publication No. 2002-0145596 published on Oct. 10, 2002 filed by Vardi, Micha; (Raanana, Ill.) entitled Apparatus and methods for hand motion tracking and handwriting recognition; and
U.S. Application Publication No. 2001-0038711 published on Nov. 8, 2002 filed by Williams, David R.; (Pomona, Calif.); Richter, Kathie S.; (Pomona, Calif.) entitled Pen-based handwritten character recognition and storage system.

In conventional systems, digital codes generated by recognizing characters entered on a digital tablet or touchscreen, or by optical character recognition of pre-written characters, identify particular characters or images that may later be rendered (displayed, printed or otherwise converted into visible or tangible form) using corresponding font images or definitions stored in a font table. As contemplated by the present invention, additional attribute data is captured during the recognition process to further describe the gestures used to create individual characters and images, and this additional attribute data is then transmitted with or stored with the character-identifying digital codes. The additional attribute data is also preferably digitally encoded and represents one or more of the following attributes of the handwriting captured by the input device:
I. Character attributes which may be used for font selection may include:
   a. character size (height and width) represented, for example by byte value integer values representing the height and width in multiples of 0.25 mm, as specified in the German draft standard DIN 16507-2;
   b. slope (which may be used to select between an italic or regular font); expressed as a byte value 0-180 representing an angle of slop in degrees, where 90 represents vertical characters with neither forward or backward slope;
   c. stylus pressure (which may be used to specify a light, regular or bold font) represented by a byte value 0-255 indicating the intensity of the applied pressure;
   d. handwriting style (e.g. cursive, block letters, etc.) represented by a coded byte value produced by the recognition engine 102;
II. Inter-character attributes may include:
   a. baseline location (e.g. a 16 bit integer integers representing the absolute vertical line position of each character in multiples of 0.25 mm);
   b. character spacing (e.g. a byte value representing the spacing from the prior character in the line in multiples of 0.25 mm);
   c. line spacing (e.g. a byte value representing the spacing in multiples of 0.25 mm from the line immediately above);
   d. character connection (e.g. a byte value indicating whether the characters are connected (script) or unconnected (block or cursive);
III. Other attributes selected by the writer may include:
   a. non-character pictographs and sketches (e.g. represented by vector graphics data or a bit-mapped image);
   b. line and text color (e.g. RGB or CYMK byte values)
   c. background color (e.g. RGB or CYMK byte values)
IV. Sensed attributes for audio to accompany writing may include:
   a. rhythms
   b. pressure or size (controlling volume)

Rythms and pressures may be stored and communicated as MIDI (Musical Instrument Digital Interface) files conforming to the industry-standard interface used on electronic musical keyboards and PCs for computer control of musical instruments and devices. Unlike digital audio files (.wav, .aiff, etc.), a MIDI file does not need to capture and store actual sounds. Instead, the MIDI file can be just a list of events which describe the specific steps that a soundcard or other playback device must take to generate certain sounds. This way, MIDI files are very much smaller than digital audio files, and the events are also editable, allowing the music to be rearranged, edited, even composed interactively, if desired. See The Midi Companion by Jeffrey Rona and Scott R. Wilkinson, Publisher: Hal Leonard (Jul. 1, 1994) ISBN: 0793530776.

The above-noted attribute data supplements the character data which identify the individual characters. This character data may take the form of convention 7 or 8 bit-per-character ASCII text, or characters specified in the much more robost Unicode. While modeled on the ASCII character set, the Unicode Standard goes far beyond ASCII's limited ability to encode only the upper- and lowercase letters A through Z. It provides the capacity to encode all characters used for the written languages of the world, and more than 1 million characters can be encoded. No escape sequence or control code is required to specify any character in any language. The Unicode character encoding treats alphabetic characters, ideographic characters, and symbols equivalently, which means they can be used in any mixture and with equal facility.

The Unicode Standard specifies a numeric value (code point) and a name for each of its characters. In this respect, it is similar to other character encoding standards from ASCII onward. In addition to character codes and names, other information is crucial to ensure legible text: a character's case, directionality, and alphabetic properties must be well defined. The Unicode Standard defines these and other semantic values, and includes application data such as case mapping tables, character property tables, and mappings to international, national, and industry character sets. The Unicode Consortium provides this additional information to ensure consistency in the implementation and interchange of Unicode data.

Individual character codes specify a particular member of a character set. Thus, the ASCII value 115 (decimal) represents the capital letter “M” in both the 7-bit ASCII character set comprising 128 characters, and in the 8-bit Extended ASCII character set comprising 256 characters, whereas Unicode values can be translated into a particular character or glyph in a much larger character set; for example, using the Arial Unicode MS font, a 16 bit Unicode value can be used to select a particular one of 51,180 different glyphs organized in ranges such as: Basic Latin; Latin-1 Supplement; Latin Extended-A; Latin Extended-B; Greek; Cyrillic; Armenian; Hebrew; Arabic; Devanagari; Bengali; Gurmukhi; Gujarati; Oriya, and many others. As used herein, the term “character set” refers to such a predetermined set of characters or glyphs which are each represented by a predetermined unique character code value.

A character set may be defined by the user and supplied to the recognition engine 102. Thus, for example, if the writer intends to write in English language characters which are satisfactorily represented by the 7-bit ASCII character set, the recognition engine may limit its output to that character set; whereas a Greek writer may indicate that the character set should be limited to a particular Unicode range. When written symbols and images cannot be converted to characters within a specified character set, they may be encoded as vector or bit-mapped image data.

Each character code may correspond to a stored font symbol which visually represents that font. For example, the Arial Unicode MS font available from Agfa Monotype Corporation is a sans serif font representing Unicode characters. In accordance with the invention, the particular font which best represents not only the individual character but also the size, shape, form, style and intensity of that character may is selected from a library of available fonts in the font storage unit 107 at the time the character and attribute data is rendered.

As indicated at 105, the encoded character identification data as well as the encoded attribute data produced by the recognition engine 102 may be passed through a data interface 105 which may take the form of a communications pathway between the source of the handwriting data a remote location where the data is converted into visual and audio form, and/or a data storage device or medium which permits the data to be reproduced at a later time.

The data from the interface 105 is rendered by utilizing the character identification data values which are used to retrieve visually reproducible characters from a font storage unit 107. Some of the character attribute data (such as character size, slope and stylus pressure) may be used to select and peculiarly modify a particular typeface (e.g., 24 point bold italic with wavy outlines). The font may also be selected based on character attribute data; for example, the character recognition engine may indicate it recognizes cursive handwriting, so that a font of script or cursive characters will be selected from the font storage unit 107. Scalable font data from the font storage unit 107 may then be modified further in accordance with the attribute data by being further sized, sized, positioned, reshaped, and rendered in the font and background color specified by the character attribute data as seen at 110 before being presented on the display 1112. Among the sensed and translated handwriting attributes are: size, character width, letter spacing, slant, baseline, line spacing, stroke acuity, form of connection, degree of connection, placement, pressure, speed, rhythm and flourishes. Thus, the gestural attributes of handwriting are captured at 101 and 102, and transmitted and/or stored as attribute data which specifies modifications to a digital font or fonts, and/or to characteristics of a range of fonts, creating a dynamic typography. Among the typographic translations are: size, character width, letter spacing, slope, baseline, line spacing, font, phrasing, position, opacity, character definition, rhythm, ornament and color.

Non-character pictographs and sketches may be encoded into vector data of the kind used in one or more vector image data formats, such as AI (Adobe Illustrator); CDR (CorelDRAW); CMX (Corel Exchange); CGM Computer Graphics Metafile; DRW (Micrografx Draw); DXF AutoCAD; and WMF Windows Metafile. Objects defined by vector data may consist of lines, curves, and shapes with editable attributes such as color, fill, and outline. When a scalable vector image is determined by the recognition engine to sufficiently similar to an image in a dictionary, its identification may be transmitted as a code value and it may be rendered by fetching the correct stored scalable image from image storage as shown at 113. Alternatively, the vector data may transmitted along with attribute data via the data interface 105. In either case, the scalable vector image data is modified as seen at 115 and combined with the attribute formatted character data on the output display 112. Among the pictographic translations are commonly recognizable, dynamically scalable or otherwise modifiable images associated with a specified content domain.

Certain captured attributes of the gestural handwriting may be captured and mapped to musical structures, generating sounds to accompany the script and/or picture writing. For example, the recognition engine 102 may capture the rhythm, intensity and motion of the handwriting gestures, convert these into sound attributes in encoded form such as a MIDI file, and transmit this sound attribute data via the data interface 105 to an audio rendering system seen at which may retrieve stored sounds and present these to an audio output device (e.g. a loudspeaker or earphones) with a rhythm and amplitude specified by the sound attribute data. Among the musical translations are: amplitude, duration, velocity or rhythm, pitch and timbre.

### Conclusion

It is to be understood that the methods and apparatus which have been described above are merely illustrative applications of the principles of the invention. Numerous modifications may be made by those skilled in the art without departing from the true spirit and scope of the invention.

1. Apparatus for capturing, storing and rendering handwriting comprising, in combination,
input means for capturing input data representing the handwriting gestures used to produce chararacters and other graphical images;
a recognition engine for translating said image data into character data specifying an ordered sequence of characters in a character set and ancillary attribute data specifying the visual chraracteristics of individual characters or groups of characters,
a font store for storing a visual symbols for representing each of said characters in a selected one of a plurality of different font styles,
a rendering device for converting said character data and said ancillary attribute data into a visual representation of said input data by selecting a font style in said font store for representing said individual characters or groups of characters in accordance with said ancillary attribute data specifying the visual characteristics of said individual characters or groups of characters.

2. Apparatus for capturing, storing and rendering handwriting as set forth in claim 1 wherein said input means comprises the combination of a writing stylus, a writing surface, and means for capturing input data representing the motion of said writing stylus with respect to said writing surface.

3. Apparatus for capturing, storing and rendering handwriting as set forth in claim 2 wherein said means for capturing additional input data further comprises means for capturing input data representing the magnitude of pressure applied to said writing surface by said writing tablet and wherein said ancillary attribute data includes data specifying said magnitude of pressure.

4. Apparatus for capturing, storing and rendering handwriting as set forth in claim 3 wherein said means for capturing additional input data further comprises means for capturing an indication of the color of said individual characters or groups of characters and wherein said rendier device includes means for representing said individual characters or groups of characters in said color.

5. Apparatus for capturing, storing and rendering handwriting as set forth in claim 2 wherein said character data specifies an ordered sequence of characters formed by said writing stylus.

6. Apparatus for capturing, storing and rendering handwriting as set forth in claim 4 wherein said ancillary attribute data comprises specifies the size of said individual characters or groups of characters.

7. Apparatus for capturing, storing and rendering handwriting as set forth in claim 6 wherein said ancillary attribute data further specifies the slope of said individual characters or groups of characters.

8. Apparatus for capturing, storing and rendering handwriting as set forth in claim 7 further comprising means for capturing additional input data representing the magnitude of pressure applied to said writing surface by said writing tablet and wherein said ancillary attribute data includes data specifying said magnitude of pressure.

9. Apparatus for capturing, storing and rendering handwriting as set forth in claim 2 wherein said input means further comprises means for capturing input timing data representing the timing or rhythm of said handwriting gestures and wherein said rendering device includes means for converting said timing data into audible form reproduced concurrently with the reproduction of said visual representation.
